(19) United States
(12) Patent Application Publication
(10) Pub. No.: US 2015/0131119 A1
(43) Pub. Date: May 14, 2015

(54) MAINTENANCE METHOD AND MAINTENANCE APPARATUS FOR INFORMATION PROCESSING APPARATUS

(71) Applicants: TOSHIBA TEC KABUSHIKI KAISHA, Tokyo (JP); KABUSHIKI KAISHA TOSHIBA, Tokyo (JP)

(72) Inventors: Masaki Narahashi, Tokyo-to (JP); Sou Miyazaki, Kanagawa-ken (JP); Yoshikatsu Kamisuwa, Tokyo-to (JP); Reiji Murakami, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/077,416

(22) Filed: Nov. 12, 2013

(51) Int. Cl. H04N 1/00; H04N 1/32

(52) U.S. Cl. CPC H04N 1/00344; H04N 1/00244; H04N 1/00206; H04N 1/32106; H04N 2201/0094
USPC 358/1.15

(57) ABSTRACT

According to one embodiment, there is provided a maintenance method for an information processing apparatus including acquiring identification information for identifying the information processing apparatus and apparatus information including setting value information of a plurality of setting items of the information processing apparatus, acquiring statistical data created on the basis of the setting value information of a plurality of the information processing apparatuses, comparing the setting value information and the statistical data for each of the plurality of setting items and presenting information concerning a setting item including an outlier, transmitting, concerning the setting item including the presented outlier, if a request for update of statistical data corresponding to the setting value is input, an update request for the statistical data to a server, and receiving information subjected to update processing in the server and updating the corresponding statistical data.

### FIELD

Embodiments described herein relate generally to a maintenance method and a maintenance apparatus for performing an analysis of an information processing apparatus such as an image forming apparatus or a POS (point of sale) terminal.

### BACKGROUND

An image forming apparatus such as a copying machine of an electrophotographic type is configured to form an image on a sheet or the like according to a cycle of charging, exposure, development, transfer, fixing, and the like. The image forming apparatus is maintained by a serviceperson. If an abnormality occurs in the image forming apparatus, a user informs the serviceperson of a state of the image forming apparatus by telephone. The serviceperson visits a setting place of the image forming apparatus and checks the state of the image forming apparatus.

Recently, in order to attain further improvement of serviceability, a method is adopted to use an image forming apparatus in an online state (a state in which the image forming apparatus is connected to a communication line such as the Internet) and, if the image forming apparatus detects an abnormality, automatically transmit information concerning a state of the image forming apparatus and an error to a service center using the communication line. For example, a model, a model number, error occurrence time, a state of the image forming apparatus, and the like are transmitted to the service center. These kinds of information are used as statistical data to perform a failure diagnosis of the image forming apparatus.

However, the statistical data used for the failure diagnosis is calculated on the basis of data of the image forming apparatus connected to the network. Data of an off-line image forming apparatus unconnected to the network is not included in the statistical data. Therefore, the statistical data does not accurately reflect market data.

The serviceperson visits the setting place of the image forming apparatus every time a periodic inspection is performed or a service call is received and performs maintenance and inspection work while checking a state using a maintenance apparatus. Setting values of the image forming apparatus are sometimes changed from setting values at the time of factory shipment by the service person according to a situation of use. However, it is likely that the setting values are set to unintended values by mistake and, as a result, the image forming apparatus causes an error. Even if a setting value is set in a normal range, a deficiency sometimes occurs because of an interaction with the other setting values.

In order to prevent the situation explained above, it is effective to indicate to the service person how the setting values are unusual compared with the market data. Therefore, the data of the setting values extracted from the image forming apparatus is read into the maintenance apparatus and it is calculated whether the data of the setting values deviating from normal ranges is present.

However, if the statistical data is insufficient and data of a sufficient number of image forming apparatuses are not collected, the statistical data cannot reflect the market data. Therefore, even if the setting values are set as normal values, since the setting values are different from the statistical data, the setting values are determined as outliers. In particular, since the number of samples of a new product is small immediately after the release of the product, statistical data of the product is biased.

On the other hand, some image forming apparatus is still in an offline state (a state in which the image forming apparatus is not connected to a communication line such as the Internet) in the market in the maintenance of the image forming apparatus. Further, there are many image forming apparatuses that, although connectable to the communication line such as the Internet, do not provide apparatus information because of security policies of setting places of the image forming apparatuses (for convenience of explanation, the image forming apparatuses in such a state are hereinafter referred to as “image forming apparatuses in the offline state”).

Therefore, there is a demand for a method of performing maintenance of image forming apparatuses by collecting apparatus information even from image forming apparatuses in the offline state and performing appropriate analysis processing on the basis of the collected apparatus information. However, information can be collected from an off-line image forming apparatus only when the serviceperson visits a setting place of the image forming apparatus. Therefore, the number of samples is small compared with an on-line image forming apparatus and decision errors often occur on the analysis processing.

The related art is disclose in, for example, JP-A 2011-17948.

### DESCRIPTION OF THE DRAWINGS

FIG. 1 is a block diagram showing an example of the configuration of a maintenance apparatus according to an embodiment;

FIG. 2 is an external view showing a relation between an image forming apparatus and the maintenance apparatus in the embodiment;

FIG. 3 is an explanatory diagram showing a relation between the image forming apparatus and a server in the embodiment;

FIG. 4 is an explanatory diagram showing an example of a table for apparatus information T1 of the maintenance apparatus in the embodiment;

FIG. 5 is an explanatory diagram for explaining an example of an error information table T2 of the maintenance apparatus;

FIG. 6 is an explanatory diagram showing an example of an apparatus setting list T3 of the maintenance apparatus;

FIG. 7 is an explanatory diagram showing an example of a statistical data list T4 of the maintenance apparatus;

FIG. 8 is an explanatory diagram showing an example of an outlier list T5 of the maintenance apparatus;

FIG. 9 is an explanatory diagram showing an example of a setting item list T6 of an image forming apparatus set as a maintenance target of the maintenance apparatus;

FIG. 10 is an explanatory diagram showing an example of an initial screen of the maintenance apparatus;

FIG. 11 is an explanatory diagram showing an example of an apparatus information acquisition screen of the maintenance apparatus;

FIG. 12 is an explanatory diagram showing an example of a server connection screen of the maintenance apparatus;

FIG. 13 is an explanatory diagram showing an example of an apparatus information analysis screen of the maintenance apparatus;

FIG. 14 is an explanatory diagram showing an example of an outlier-of-setting screen of the maintenance apparatus;

FIG. 15 is a flowchart for explaining an apparatus information acquisition operation of the maintenance apparatus;

FIG. 16 is a flowchart for explaining a server connection operation of the maintenance apparatus;

FIG. 17 is a sub-flowchart for explaining a statistical data acquisition operation of the maintenance apparatus;

FIG. 18 is a flowchart for explaining an outlier display operation of the maintenance apparatus;

FIG. 19 is a flowchart for explaining an operation of statistical data update processing of the maintenance apparatus;

FIG. 20 is an explanatory diagram showing an example of a list for statistical data update T7 of the maintenance apparatus; and

FIG. 21 is a flowchart for explaining an operation of statistical data list update processing by the server in the embodiment.

### DETAILED DESCRIPTION

It is an object of embodiments to provide a maintenance method and a maintenance apparatus for updating statistical data and performing an analysis of an information processing apparatus if, although setting values are normal, statistical data corresponding to the setting values deviates from the setting values.

In general, according to an embodiment, there is provided a maintenance method for an information processing apparatus including: acquiring identification information for identifying the information processing apparatus and apparatus information including setting value information of a plurality of setting items of the information processing apparatus; acquiring statistical data created on the basis of the setting value information of a plurality of the information processing apparatuses; comparing the setting value information and the statistical data for each of the plurality of setting items and presenting information concerning a setting item including an outlier; transmitting, concerning the setting item including the presented outlier, if a request for update of statistical data corresponding to the setting value is input, an update request for the statistical data to a server; and receiving information subjected to update processing in the server and updating the corresponding statistical data.

A maintenance apparatus for an information processing apparatus according to an embodiment is explained in detail below with reference to the drawings. In the figures, the same components are denoted by the same reference numerals and signs.

### Embodiment

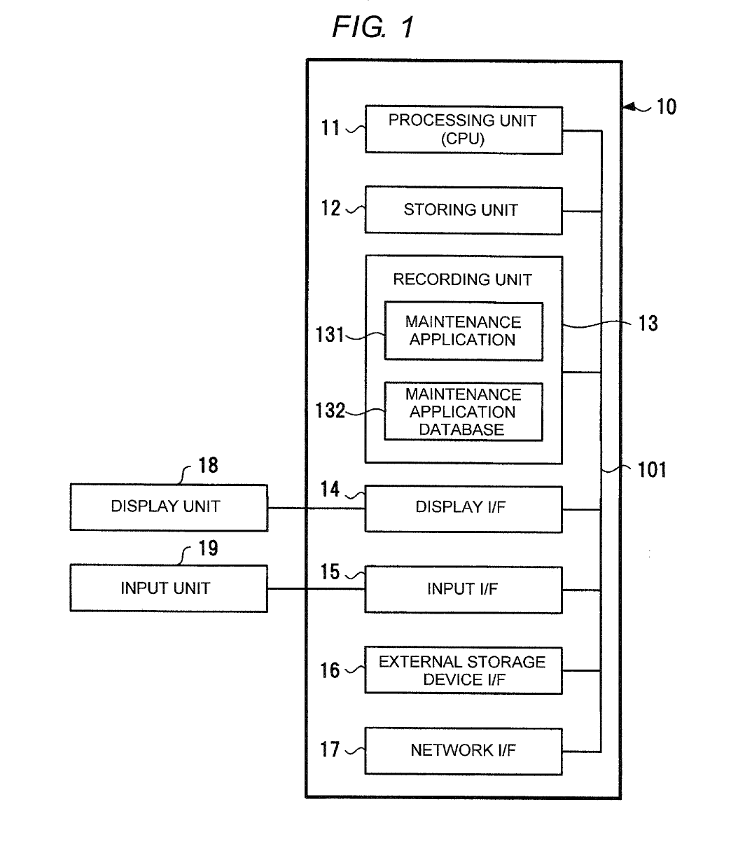

FIG. 1 is a block diagram showing an example of the configuration of a maintenance apparatus 10 according to the embodiment. As shown in FIG. 1, the maintenance apparatus 10 includes a processing unit 11, which is a controller such as a CPU, a storing unit 12 such as a memory, a recording unit 13 such as a HDD, a display interface (I/F) 14, an input interface (I/F) 15, an external storage device interface (I/F) 16, and a network interface (I/F) 17. The processing unit 11, the storing unit 12, the recording unit 13, the display I/F 14, the input I/F 15, the external storage device I/F 16, and the network I/F 17 are connected to one another via a bus line 101.

The display I/F 14 is connected to a display unit 18 such as a liquid crystal display. The display I/F 14 supplies image information to the display unit 18. The input I/F 15 is connected to an input unit 19 including a mouse and a keyboard. The input I/F 15 sends an instruction or the like input from the input unit 19 to the processing unit 11. The external storage device I/F 16 is an interface with an external storage device. As the external storage device, a detachable external storage device such as a USB (Universal Serial Bus) memory is used. The network I/F 17 is an interface that performs communication with a network such as the Internet.

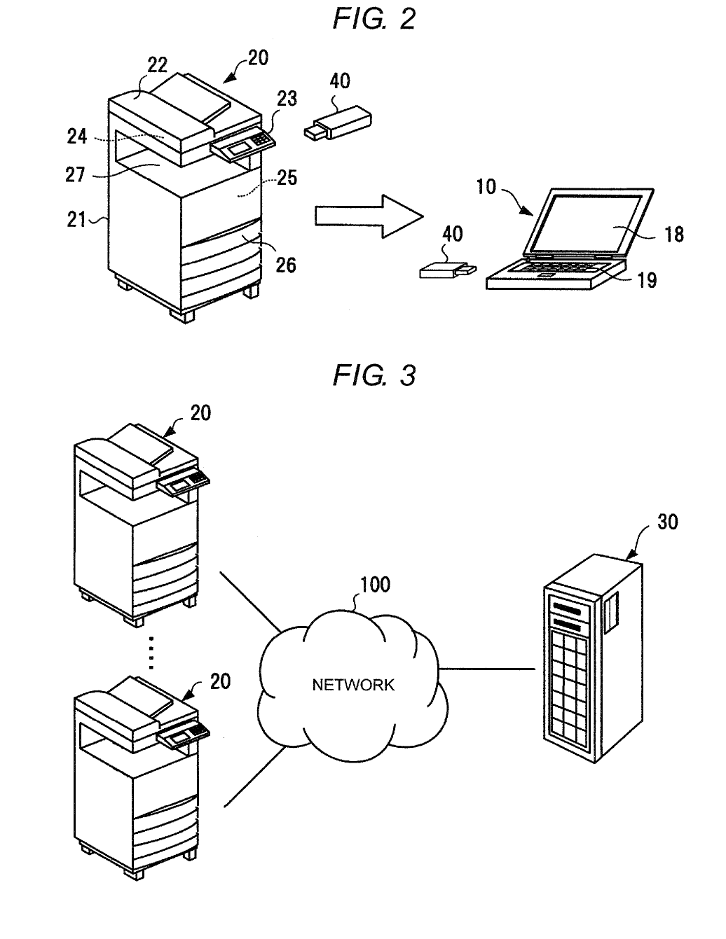

The maintenance apparatus 10 is based on the premise that a serviceperson carries the maintenance apparatus 10 into a setting place of an image forming apparatus. Therefore, a form portable by the serviceperson, for example, a form equivalent to a notebook personal computer shown in FIG. 2 is desirable.

In the embodiment, as shown in FIG. 2, it is assumed that setting value information and the like of an image forming apparatus 20 are supplied to the maintenance apparatus 10 offline via a detachable external storage medium such as a USB (Universal Serial Bus) memory 40 rather than being supplied to the maintenance apparatus 10 or the like online via a network 100.

This takes into account the fact that, in the present market, a large number of information processing apparatuses such as image forming apparatuses in an offline state (a state in which the information processing apparatuses are not connected to a communication line such as the Internet) are still present and there are many information processing apparatuses that, although connected to the communication line such as the Internet, do not provide apparatus information because of security policies of setting places of the information processing apparatuses.

In the following explanation, the image forming apparatus 20 is explained as an example of an information processing apparatus. However, the explanation can also be applied to a POS (point of sale) terminal and the like. An MFP, which is a complex machine, is explained as an example of the image forming apparatus 20. However, the explanation can also be applied to other image forming apparatuses such as a copying machine, a printer, a scanner, and a facsimile.

FIG. 2 is an external view showing a relation between the MFP (the image forming apparatus) 20 and the maintenance apparatus 10. A document table is present in an upper part of a main body 21 of the MFP 20. An auto document feeder (ADF) 22 is openably and closably provided on the document table. An operation unit 23 is provided in an upper part of the main body 21. The operation unit 23 includes various operation keys and a display unit of a touch panel type.

A scanner unit 24 is provided in a lower part of the ADF 22 in the main body 21. The scanner unit 24 reads a document fed by the ADF 22 or a document placed on the document table and generates image data. A printer unit 25 is provided in the center in the main body 21. A plurality of cassettes 26 for storing sheets of various sizes are provided further in a lower part of the main body 21.

The printer unit 25 includes a photoconductive drum and a laser. The printer unit 25 processes the image data read by the scanner unit 24 or image data created by a PC (Personal Computer) or the like and forms and fixes an image on a sheet. The sheet having the image fixed thereon by the printer unit 25 is discharged to a paper discharge unit 27.

A port for connecting the USE memory 40, which is the external storage medium, is provided on a side surface of the main body 21 of the MFP 20. The USE memory 40 is detachably attachable to the port. When the USB memory 40 is connected to the port of the MFP 20, various kinds of information such as apparatus information of the MFP 20 can be captured into and stored in the USB memory 40.

A port for connecting the USB memory 40 is also provided in the maintenance apparatus 10. Various kinds of information such as apparatus information of the MFP 20 stored in the USB memory 40 can be captured into the maintenance apparatus 10 via the external storage device I/F 16. Therefore, the external storage device I/F 16 configures an apparatus information acquiring unit.

FIG. 3 is an explanatory diagram showing a relation between the MFP (the image forming apparatus) 20 and a server 30. As shown in FIG. 3, a plurality of or a singularity of the MFP 20 is connected to the network 100. The server 30 that performs, for example, an analysis of information is connected to the network 100. In a state in which the MFP 20 is connected to the network 100, the server 30 automatically collects and accumulates apparatus information including setting value information of the MFP 20 and creates statistical data. In the server 30, the statistical data is updated according to the collected and accumulated setting value information. The maintenance apparatus 10 acquires the statistical data from the server 30 via the network I/F 17. Therefore, the network I/F 17 configures a statistical-data acquiring unit.

The recording unit 13 of the maintenance apparatus 10 in the embodiment stores therein a maintenance application 131 for an image forming apparatus (hereinafter referred to as “application”). The recording unit 13 includes a database 132 for a maintenance application (hereinafter referred to as “database”). The statistical data (explained below) created by the server 30 can be downloaded and stored in the database 132.

The database 132 is configured by, for example, tables (a) to (g) described below.

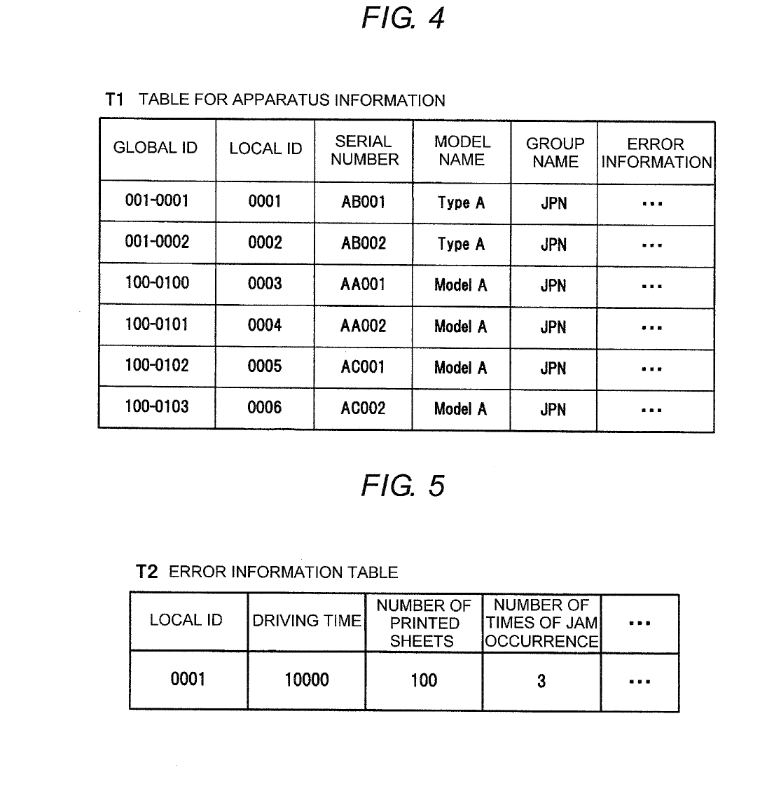

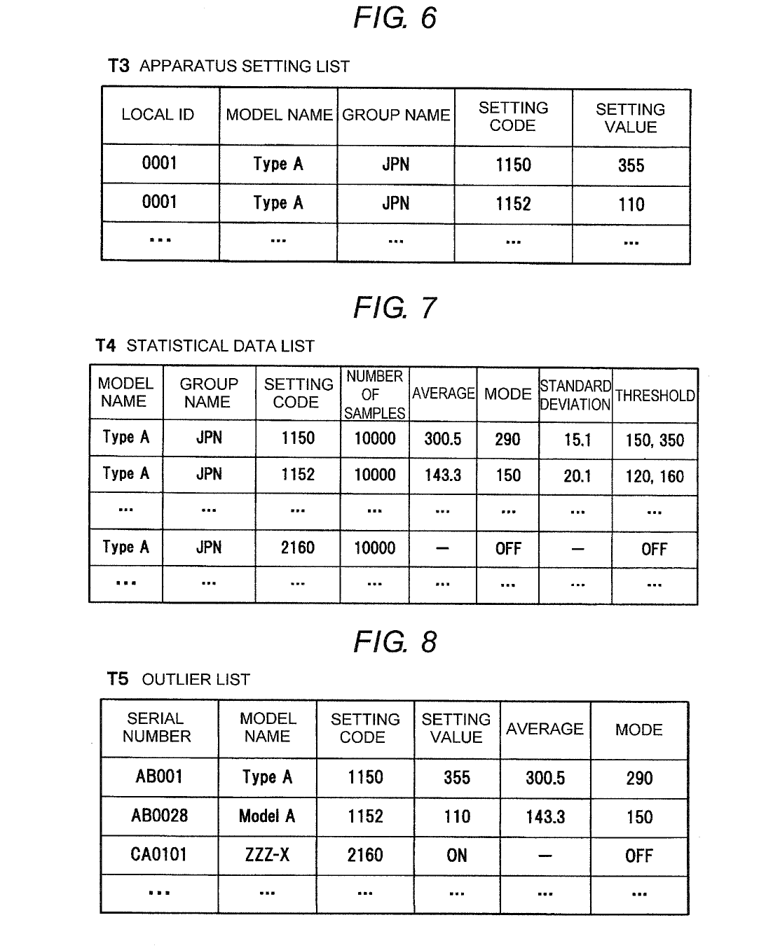

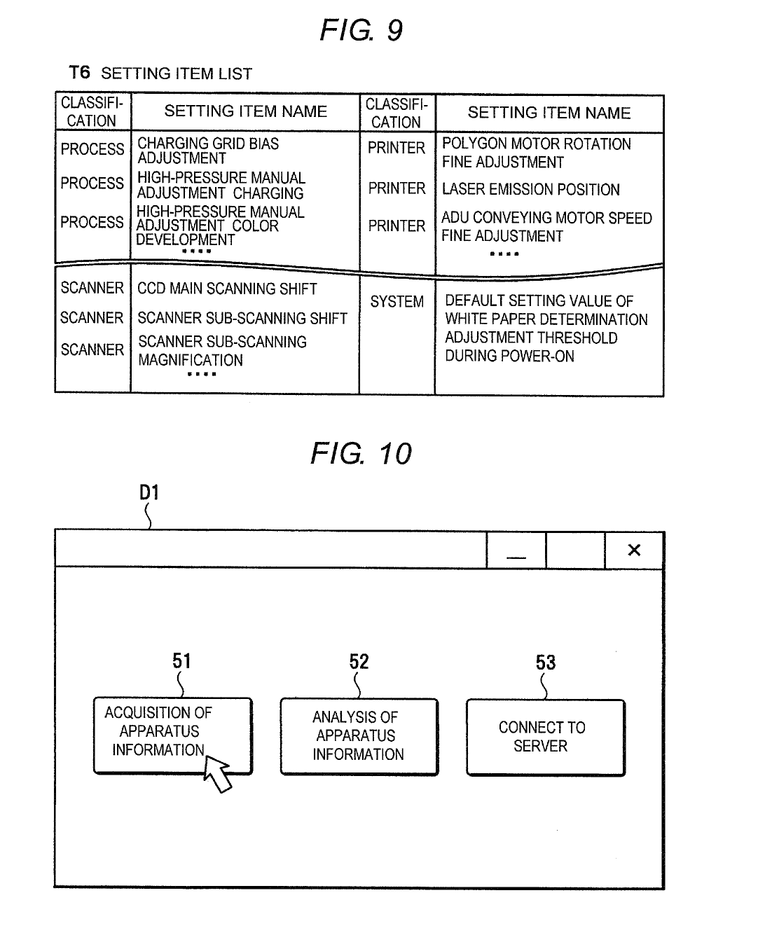

(a) Table for apparatus information T1 (FIG. 4)
(b) Error information table T2 (FIG. 5)
(c) Apparatus setting list T3 (FIG. 6)
(d) Statistical data list T4 (FIG. 7)
(e) Outlier list T5 (FIG. 8)
(f) Setting item list T6 (FIG. 9)

The image forming apparatus 20 includes an MFP, a printer, a scanner, and a facsimile.

As shown in FIG. 4, the table for apparatus information T1 is configured by columns of a global ID, a local ID, a serial number, a model name, a group name, and error information of the image forming apparatus 20. That is, the table for apparatus information T1 includes apparatus information including a global ID, which is an identification number peculiar to each of image forming apparatuses and given by the server 30, a local ID, which is a reference number in the table for apparatus information T1, a serial number, which is an identification number peculiar to each of image forming apparatuses and given from a manufacturer, a model name for specifying a model, a group name for classifying an image forming apparatus into a specific group, for example, a destination or a region, and error information.

The global ID is a number or a character string allocated by the server 30 anew if a peculiar number (a serial number) allocated to an image forming apparatus by a manufacturer is cannot be sufficiently trusted, for example, if image forming apparatuses of a plurality of manufactures are centrally managed. Therefore, the server 30 issues the global ID on the basis of a plurality of items necessary for narrowing down the image forming apparatuses to one. Specific examples of the global ID are (manufacturer name+serial number), (model name+serial number), and the like.

As shown in FIG. 5, the error information table T2 is configured by columns of a local ID, a driving time, the number of printed sheets, and the number of times of jam occurrence of the image forming apparatus 20. That is, the error information table T2 includes a local ID, which is a reference number in the table for apparatus information T1, a driving time, which is time in which the image forming apparatus 20 is driven, the number of printed sheets, which is a total number of printed sheets printed by the image forming apparatus 20 or the number of printed sheets in one day, and the number of times of jam occurrence, which records the number of times sheets and the like cause jam in the image forming apparatus 20.

As shown in FIG. 6, the apparatus setting list T3 is configured by columns of a local ID, which is a reference number in the apparatus setting list T3, a model name for specifying a model of the image forming apparatus 20, a group name representing a destination or a region (e.g., Japan, North America, or Europe), a setting code, which is a code allocated to a setting item of the image forming apparatus 20 set as an evaluation target, and a setting value, which is a value set in the setting item.

As shown in FIG. 7, the statistical data list T4 is configured by columns of a model name for specifying the image forming apparatus 20, a group name representing a destination or a region (e.g., Japan, North America, or Europe), a setting code, which is a code allocated to a setting item of the image forming apparatus 20, the number of samples, which means the number of samples used in creating statistical data, an average, which is an average of values of the samples, a mode, which means a value most often appearing in the samples, a standard deviation of the samples, and a threshold used for determining whether a setting value is determined as an outlier.

As shown in FIG. 8, the outlier list T5 is configured by columns of a serial number, which is an identification number peculiar to each of image forming apparatuses and given from a manufacturer, a model name for specifying a model, a setting code, which is a code allocated to a setting item of the image forming apparatus 20, a setting value, which is a value set in the setting item, an average, which is an average of values of samples, and a mode, which means a value most often appearing in the samples.

Further, as shown in FIG. 9, the setting item list T6 is a list of setting items of the image forming apparatus 20 set as an evaluation target. The setting item list T6 includes, in classification, a setting item concerning a process, a setting item concerning a scanner, a setting item concerning a printer, and a setting item concerning a system.

In FIG. 9, an example of the setting items is shown. As the setting item concerning a process, there are charging grid bias adjustment, high-pressure manual adjustment charging, high-pressure manual adjustment color development, and the like. As the setting item concerning a scanner, there are CCD main scanning shift, scanner sub-scamming shift, and the like. As the setting item concerning a printer, there are polygon motor rotation fine adjustment, laser emission position, ADU conveying motor speed fine adjustment, and the like. Further, as the setting item concerning a system, there is a default setting value of a white paper determination adjustment threshold during power-on.

In the embodiment, the data recorded in the database 132 is only an example. An actual configuration is not limited to the example explained above. The database 132 may be configured by a single table, may be configured from a plurality of tables (on the basis of a relational data model), or may be configured by a substitute for the database such as a CSV (Comma Separated Value) file.

In the server 30, a plurality of the image forming apparatuses 20 connected to the network 100 are managed by a database. By using a serial number and a model name as main keys, it is possible to uniquely determine the image forming apparatus 20 managed by the server 30 irrespective of whether the image forming apparatus 20 is an in-house product or a product of another company. Besides the serial number and the model name, the serial number and a manufacturer name or the like may be combined.

The operation of the maintenance apparatus 10 according to the embodiment is explained. When the application 131 is started, the maintenance apparatus 10 displays an initial screen on the display unit 18 through the display I/F 14.

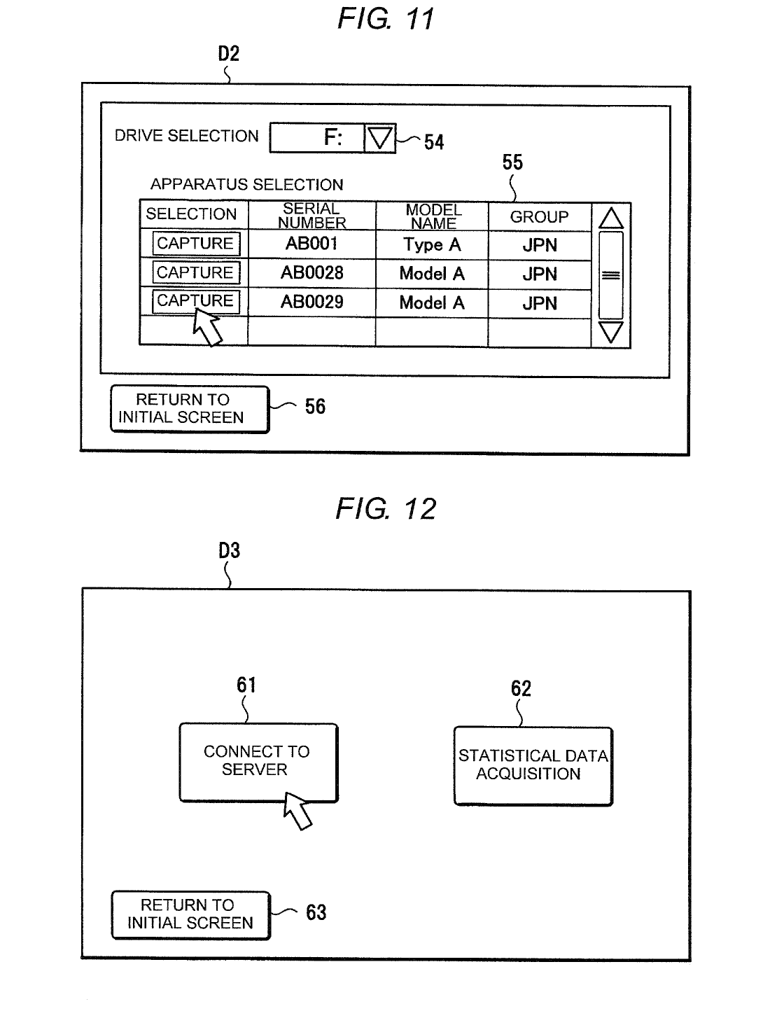

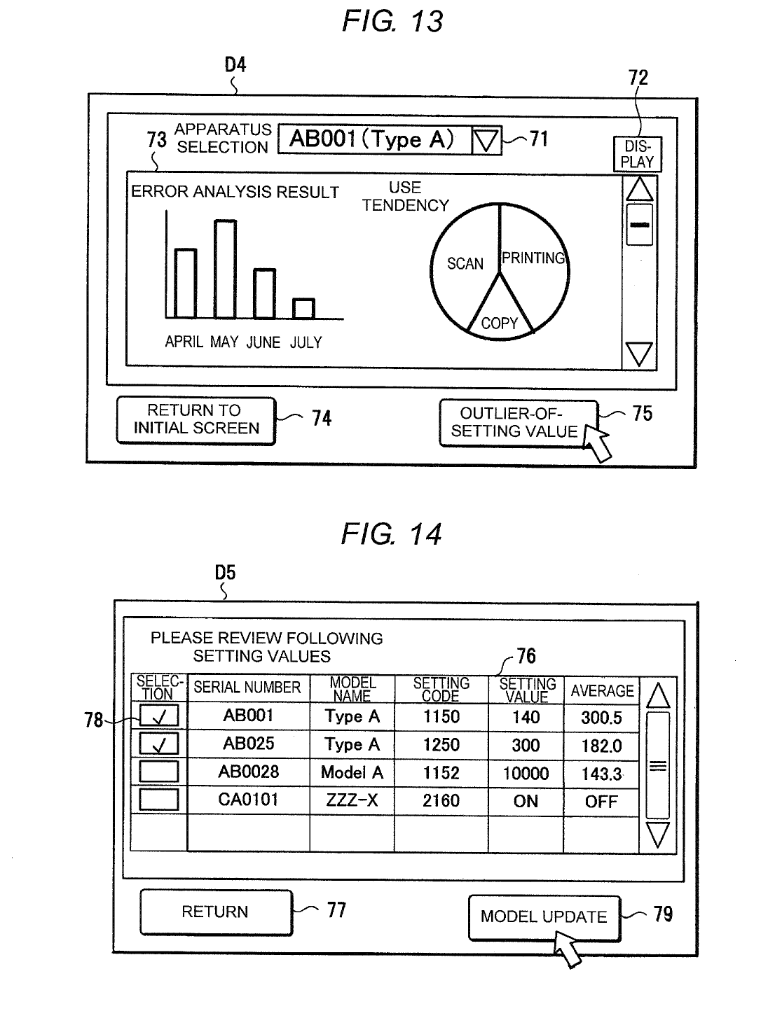

That is, a screen of the application 131 of the maintenance apparatus 10 includes a plurality of operation screens to which the screen transitions from an initial screen D1 shown in FIG. 10. If “acquisition of apparatus information” is selected on the initial screen D1, the screen transitions to an acquisition screen D2 for apparatus information shown in FIG. 11. If “connect to the server” is selected, the screen transitions to a screen D3 for connect to the server shown in FIG. 12. If “analysis of apparatus information” is selected, the screen transitions to an analysis screen D4 for apparatus information shown in FIG. 13. If “outlier-of-setting display” is selected on the analysis screen D4 for apparatus information, the screen transitions to an outlier-of-setting screen D5 shown in FIG. 14.

As shown in FIG. 10, on the initial screen D1, three menus, i.e., “acquisition of apparatus information” 51, “analysis of apparatus information” 52, and “connect to the server” 53 are prepared. A user operates the input unit 19 to select, out of the menus, a function that the user desires to execute. If the operation is performed, the operation is input to the maintenance apparatus 10 through the input I/F 15.

FIG. 11 shows an example of the acquisition screen D2 for apparatus information. As shown in FIG. 11, the acquisition screen D2 for apparatus information includes drive selection 54 for designating an external storage device in which data of an image forming apparatus is stored, an apparatus selection list 55 for causing the user to designate data of which image forming apparatus is input to the database 132, and a return-to-initial-screen button 56.

FIG. 12 shows an example of the screen D3 for connect to the server. As shown in FIG. 12, on the screen D3 for connect to the server, a connect-to-server button 61 and a statistical data acquisition button 62 are displayed. If any one of the buttons is selected, processing corresponding to the button is executed. The screen D3 for connect to the server includes a return-to-initial-screen button 63.

FIG. 13 shows an example of an analysis screen D4 for apparatus information. As shown in FIG. 13, on the analysis screen D4 for apparatus information, an apparatus selection button 71, a display button 72, an analysis result display section 73, a return-to-initial-screen button 74, and an outlier-of-setting button 75 are displayed.

FIG. 14 shows an example of the outlier-of-setting screen D5. As shown in FIG. 14, on the outlier-of-setting screen D5, an outlier display section 76 in which an outlier (explained below) is displayed, a return button 77, a check button 78, and a model update button 79 are displayed. If the return button 77 is selected, the screen returns to the analysis screen D4 for apparatus information (FIG. 13).

If the display button 72 is pressed on the screen shown in FIG. 13, the maintenance apparatus 10 analyzes and totalizes error information and counter information such as the number of printed sheets of an image forming apparatus selected in an apparatus selection list 71 and presents a tendency of an error and a state of use of the image forming apparatus in the analysis result display section 73, for example, as a diagram. If the return-to-initial-screen button 74 is selected, the screen transitions to the initial screen D1 (FIG. 10). If the outlier-of-setting button 75 is selected, the screen transitions to the outlier-of-setting screen D5 (FIG. 14). If there are a plurality of image forming apparatuses that can be displayed, an image forming apparatus is selected from the apparatus selection list 71.

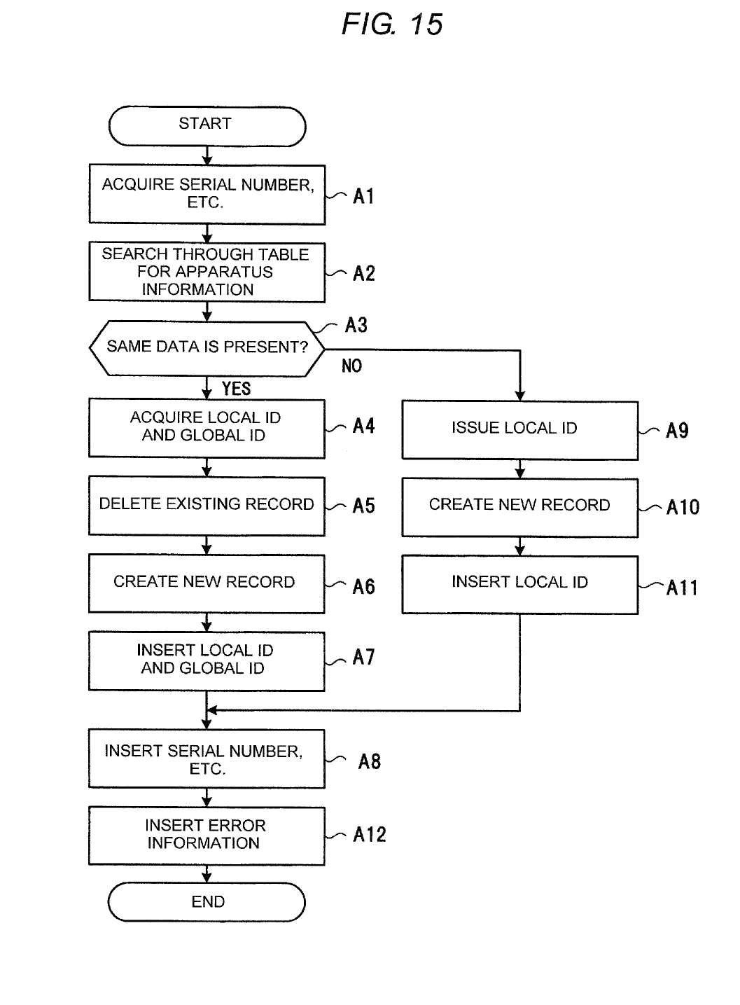

The operation of the maintenance apparatus 10 according to an embodiment is explained with reference to flowcharts of FIGS. 15 to 18 focusing on acquisition of apparatus information, acquisition of statistical data, and detection processing for an outlier. The operation explained with reference to the flowcharts is executed under the control by the processing unit (the CPU) 11 according to a computer program of the application 131 stored in the recording unit 13. Therefore, the processing unit (the CPU) 11 executes various kinds of processing by the application 131 in the following explanation.

### Acquisition of Apparatus Information

On the acquisition screen D2 for apparatus information (FIG. 11), according to the application 131, the CPU 11 causes the user to designate an external storage device in the drive selection 54, urges the user to connect the external storage device such as the USB memory 40 to the external storage device I/F 16, and checks whether data that can be added to the database is present in the external storage device (the USB memory 40). If data that can be added to the database is present, the CPU 11 adds, to the apparatus selection list 55, a serial number and a model name of an image forming apparatus including data that can be acquired.

That is, in the flowchart of FIG. 15, if the data to be acquired is determined, in Act A1, the CPU 11 acquires a serial number, a model name, error information, and setting value information of the selected image forming apparatus. In Act A2, the CPU 11 scans (searches through) the table for apparatus information T1 (FIG. 4) in the database 132. In Act A3, the CPU 11 checks, on the basis of the serial number and the model name, whether data of an image forming apparatus same as the data to be acquired is present. At this point, according to the application 131, serial numbers and model names of the data to be acquired and the data in the database 132 are scanned.

If data whose two items, i.e., the serial numbers and the model names coincide with each other are present in the data to be acquired and the data in the database 132 (YES in the determination in Act A3), the CPU 11 determines that the image forming apparatus is “the same image forming apparatus” and proceeds to processing in Act A4. If data whose two items, i.e., the serial numbers and the model names coincide with each other are absent (NO in the determination in Act A3), the CPU 11 proceeds to processing in Act A9.

The CPU 11 scans the model names simultaneously with scanning the serial numbers because, usually, a serial number is the only number in the same manufacturer but is not considered to be the only number if a plurality of manufacturers are set as maintenance targets. Therefore, the CPU 11 scans the model names simultaneously with scanning the serial numbers. It is also effective to scan not only the model names but also manufacturer names together with the serial numbers. If it is guaranteed that serial numbers do not overlap, for example, when a maintenance target is only one manufacturer, the CPU 11 may scan only the serial numbers.

In Act A3, the CPU 11 determines whether an image forming apparatus having the same serial number and the same model name is present. If an image forming apparatus having the same serial number and the same model name is present (YES in the determination in Act A3), in Act A4, the CPU 11 issues a global ID and a local ID same as a global ID and a local ID of existing data to the data to be acquired. In Act A5, the CPU 11 deletes the existing data (record). In Act A6, the CPU 11 creates new data (record). In Act A7, the CPU 11 inserts the local ID and the global ID of the data to be acquired into the table for apparatus information T1. If the global ID is not allocated, the CPU 11 inserts a value determined in advance such as null or −1. Further, in Act A8, the CPU 11 inserts a serial number, a model name, and a group name into the table for apparatus information T1. The group name is a group name designated in the apparatus selection list 55. Besides being designated by the user in the apparatus selection list 55, the group name may be automatically discriminated for each destination or each region.

If the CPU 11 determines in Act A3 that an image forming apparatus having the same serial number and the same model name is absent (NO in the determination in Act A3), in Act A9, the CPU 11 issues a local ID anew. The local ID is determined not to overlap local IDs in the application 131. For example, the local ID takes a positive integer value and is obtained by incrementing a maximum local ID among issued local IDs by 1. In this method, a value of the local ID increases by 1 every time the local ID is issued. Therefore, local IDs do not overlap.

In Act A10, the CPU 11 creates a new record in the table for apparatus information T1. In Act A11, the CPU 11 inserts the local ID of the data to be acquired into the table for apparatus information T1. Further, in Act A8, the CPU 11 inserts a serial number, a model name, and a group name into the table for apparatus information T1.

Subsequently, in Act A12, the CPU 11 inserts error information and setting value information of the image forming apparatus respectively into the tables T1 and T2. The processing for capturing apparatus information ends.

### Connection to the Server

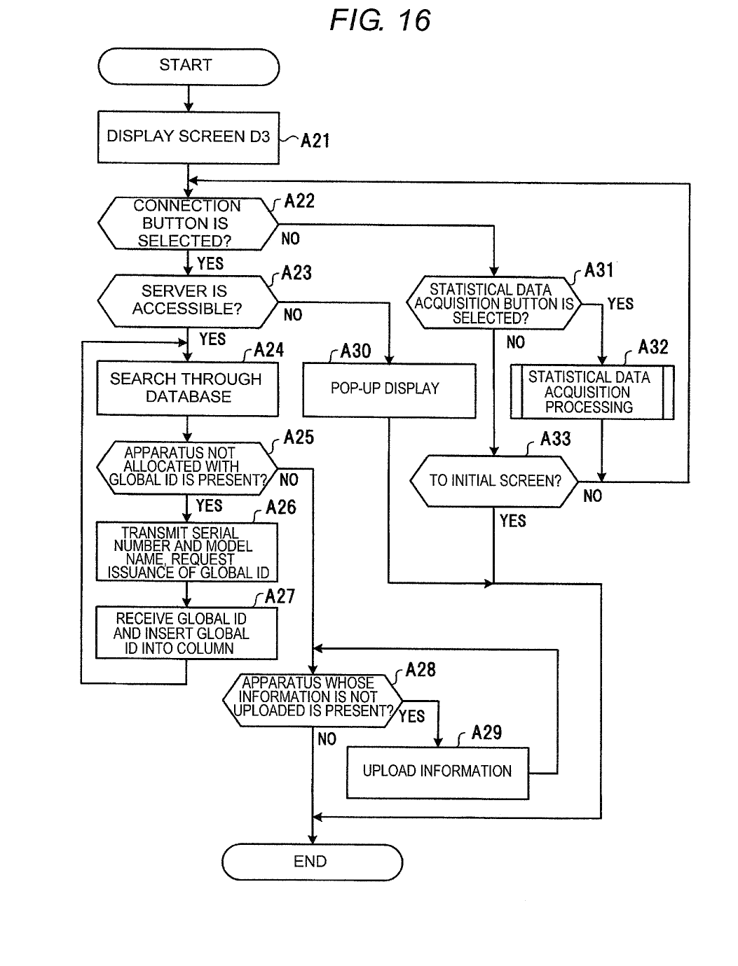

Processing for connection to the server 30 is explained with reference to the flowchart of FIG. 16. If the “connect to the server” 53 is selected by the user on the initial screen D1 (FIG. 10), in Act A21, the CPU 11 displays the screen D3 for connect to the server 30 (FIG. 12). Subsequently, in Act A22, the CPU 11 determines whether the connect-to-server button is selected. If the CPU 11 determines that the connect-to-server button 61 is selected, in Act A23, the CPU 11 checks, through the network I/F 17, whether the server 30 is accessible for data collection.

If the server 30 is accessible (YES in the determination in Act A23), in Act A24, the CPU 11 searches through the table for apparatus information T1 in the database 132. In Act A25, the CPU 11 checks whether data not allocated with a global ID yet is present.

If data not allocated with a global ID yet is present (YES in the determination in Act A25), in Act A26, the CPU 11 transmits (uploads) a serial number and a model name of an image forming apparatus to the server 30 and requests the server 30 to issue a global ID. When a global ID is issued from the server 30, in Act A27, the CPU 11 receives the issued global ID and inserts the global ID into the column of the global ID of the table for apparatus information T1. Thereafter, the CPU 11 returns to Act A24 and repeats the same processing.

If global IDs are allocated to all image forming apparatuses and the determination in Act A25 is NO, in Act A28, the CPU 11 determines whether an image forming apparatus whose information is not uploaded is present. If an image forming apparatus whose information is not uploaded remains (YES in the determination in Act A28), in Act A29, the CPU 11 uploads a global ID, error information, a group name, and setting value information of the image forming apparatus to the server 30. If an image forming apparatus whose information is not uploaded is absent in Act A28 (No in the determination in Act A28), the CPU 11 returns to the initial screen D1.

If the CPU 11 determines in Act A23 that the server 30 is inaccessible (No in the determination in Act A23), in Act A30, the CPU 11 pop-up displays to the effect that the server 30 is inaccessible and returns to the initial screen D1.

If the connect-to-server button 61 for connection to the server 30 is not selected (NO in the determination in Act A22), in Act A31, the CPU 11 determines whether the statistical data acquisition button 62 (FIG. 12) is selected. If the statistical data acquisition button 62 is selected (YES in the determination in Act A31), in Act A32, the CPU 11 performs processing for acquiring statistical data. If the statistical data acquisition button 62 is not selected (NO in the determination in Act A31), in Act A33, the CPU 11 determines whether the return-to-initial-screen button 63 (FIG. 12) is selected. If the return-to-initial-screen button 63 is selected (YES in the determination in Act A33), the CPU 11 returns to the initial screen D1. If the return-to-initial-screen button 63 is not selected (NO in the determination in Act A33), the CPU 11 returns to Act A22.

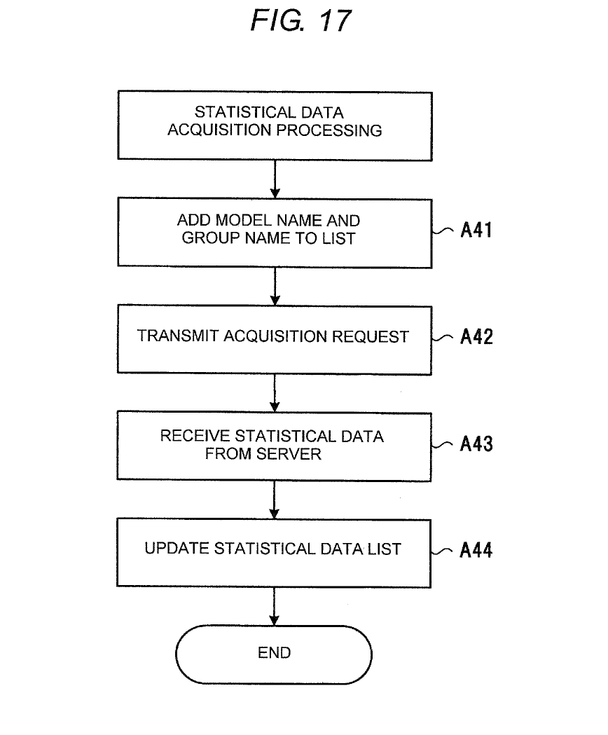

A sub-flow of Act A32 in which the maintenance apparatus 10 acquires statistical data from the server 30 is explained with reference to the flowchart of FIG. 17. First, in Act A41, the CPU 11 acquires all pairs of model names and group names from the table for apparatus information T1 and adds the pairs of the model names and the group names to the list. However, overlapping pairs of model names and group names in the list are excluded. In Act A42, the CPU 11 transmits the list of the model names and the group names and an acquisition request for statistical data to the server 30.

The server 30 transmits, concerning model names and group names corresponding to the received list, a statistical data list calculated in advance. In the maintenance apparatus 10, in Act A43, the CPU 11 receives the statistical data list from the server 30. In Act A44, the CPU 11 updates the existing statistical data list T4 (FIG. 7) with the statistical data list acquired anew. The statistical data acquisition processing ends.

The statistical data list T4 of the setting values is configured by, for example, a model name, a group name, a setting code, the number of samples, an average, a mode, a standard deviation, and a threshold as shown in FIG. 7.

### Outlier Detection Processing

If the outlier-of-setting button 75 is selected on the analysis screen D4 of the apparatus information shown in FIG. 13, the CPU 11 executes outlier detection processing and transitions to the outlier-of-setting screen D5 shown in FIG. 14. An outlier is evaluation information indicating whether setting values of an image forming apparatus are appropriate, i.e., appropriateness of the setting values. A setting value of each of setting items of the image forming apparatus and statistical data are compared. If there is a setting value exceeding an allowable range set in advance with respect to a value of the statistical data, an outlier is displayed to the user to present an evaluation result of the setting values.

The outlier detection processing may be executed in parallel to capturing of apparatus information from the external storage device (the USB memory 40) or may be arbitrarily executed on already-captured data in response to user operation. In the following explanation, the user arbitrarily executes the outlier detection processing.

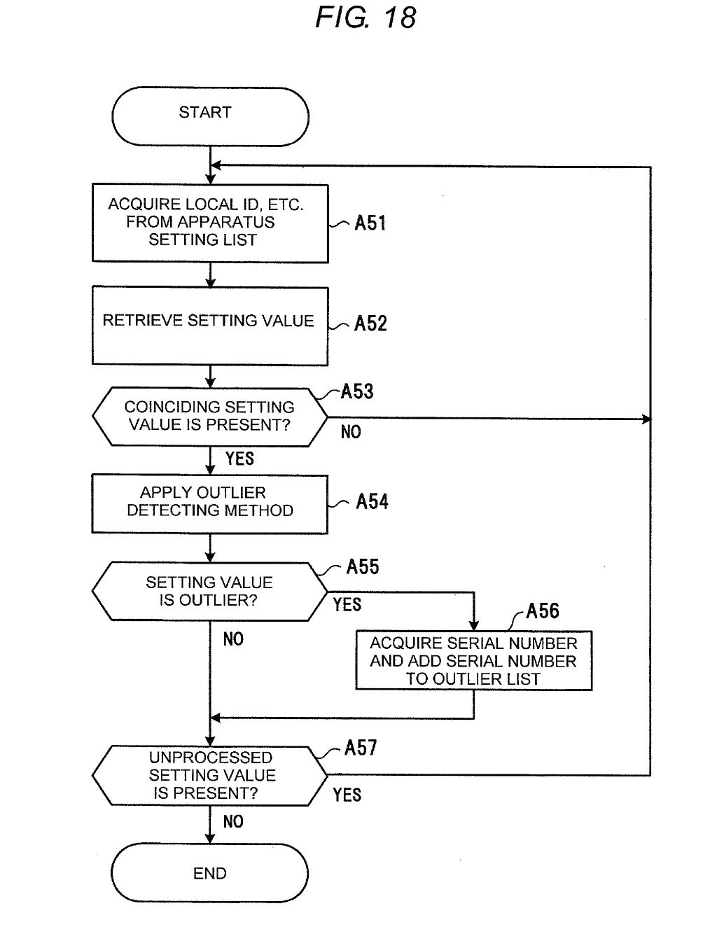

The outlier detection processing is carried out targeting all data included in the apparatus setting list T3 (FIG. 6). The flowchart of FIG. 18 shows the operation of the outlier detection processing.

First, in Act A51, the CPU 11 acquires a local ID, a model name, a group name, and a setting code from the apparatus setting list T3 (FIG. 6). In Act A52, the CPU retrieves, from the statistical data list T4 (FIG. 7), a setting value of a row in which a model name, a group name, and a setting code coincide with the acquired model name, the group name, and the setting code. In Act A53, the CPU 11 determines whether a coinciding setting value is present. If the CPU 11 determines that a coinciding setting value is present (YES in the determination in Act A53), the CPU 11 applies the average, the standard deviation, and an outlier detecting method. If a coinciding setting value is absent in Act A53 (NO in the determination in ACT A53), the CPU 11 returns to Act A51 and shifts to processing for the next setting code.

In Act A54, the CPU 11 applies the outlier detecting method. If the setting items are nominal scales and the average is not calculated, the CPU 11 acquires the mode. If the setting value does not coincide with the mode, the CPU 11 sets the setting value as an outlier. In Act A55, the CPU 11 determines whether the setting value is the outlier. If the CPU 11 determines that the setting value is the outlier (YES in the determination in Act A55), the CPU 11 proceeds to Act A56.

In Act A56, the CPU 11 searches through, in the table for apparatus information T1 (FIG. 4), a row in which a local ID coincide with the acquired local ID, acquires a serial number, and adds the serial number, the model name, the setting code, the setting value, and the mode to the outlier list T5 shown in FIG. 8. In Act A57, the CPU 11 determines whether an unprocessed setting value is present. If an unprocessed setting value is present (YES in the determination in Act A57), the CPU 11 returns to Act A51 and repeats the processing until no unprocessed setting value is left.

If there is an average among the setting values, the CPU applies the outlier detecting method. The outlier detecting method is explained below. If the setting value is an outlier, the CPU 11 searches for, in the table for apparatus information T1 (FIG. 4), a row in which a local ID coincides with the acquired local ID and acquires a serial number. The CPU 11 adds the serial number, the model name, the setting code, the setting value, the average, and the mode to the outlier list T5 (FIG. 8). The CPU 11 carries out the process explained above for all the model names and all the setting codes registered in the apparatus setting list T3 (FIG. 6).

The outlier detecting method is explained below. There is a method of assuming that a setting value conforms to a normal distribution and, if the setting value is larger than an average by a triple of a standard deviation, regarding the setting value as an outlier. When the setting value is represented as x, the average is represented as μ, and the standard deviation is represented as σ, a setting value satisfying the following conditional expression (1) is an outlier:

|x−μ|σ>3 (1)

This method is a general method for outlier detection. Usually, this method is used. A double of the standard deviation is sometimes used instead of the triple of the standard deviation. By using the double, a larger number of setting values can be extracted as outliers.

A Mahalanobis distance may be used for the outlier detection. A Mahalanobis distance D_{M} is defined as indicated by Expression (2):

D_{M}=√(x−μ)^{T}Σ⁻¹(x−μ) (2)

In the expression, Σ represents a variance-covariance matrix. If a plurality of setting values are related to one another and the variance-covariance matrix is calculated by the server 30 in advance, it is advisable to use this expression. A Mahalanobis distance at the time when setting values related to one another are absent and an independent setting value is evaluated is calculated by Expression (3):

D_{M}=√(x−μ)/σ)² (3)

If D_{M} exceeds a threshold, x is determined as an outlier. In the setting items, there is a range of recommended setting determined in a design stage. A setting value exceeding the range can be regarded as an outlier. When a lower limit of the threshold is represented as θ1 and an upper limit of the threshold is represented as θh, a setting value x satisfying the following Expression (4) is determined as an outlier:

x<θ1,

θh<x (4)

The three kinds of outlier detecting methods are illustrated above. However, a method is not limited to the outlier detecting methods. For example, a method of statistically selecting an outlier such as Smirnov-Grubbs test can also be adopted.

When the outlier detection processing ends, the CPU 11 displays content of the outlier list T5 (FIG. 8) on the outlier display section 76 shown in FIG. 14 and calls user's attention. For a setting code not including an average, a mode is displayed instead of the average. The setting outliner screen shown in FIG. 14 is an example. Setting items unusually set for each of image forming apparatuses are listed and indexes serving as reference for setting are shown.

Beside being indicated by a numerical value, the outlier is sometimes indicated by ON or OFF or the like. For example, in FIG. 14, concerning a setting code 2160 of an image forming apparatus having a serial number CA0101, a function that should be usually OFF is ON. Therefore, the outlier, which is evaluation information, is not limited to a numerical value and only has to present deviation information indicating appropriateness of a setting value. A display form is not limited to the example shown in the figure.

The detection of an outlier is performed by the processing unit (the CPU) 11. Therefore, the processing unit 11 configures an outlier detecting unit.

As explained above, the setting items unusually set for each of the image forming apparatuses are listed and the index (the outlier) serving as reference for setting are shown taking into account locality of the setting values due to a destination or the like. Consequently, it is possible to urge the user to review the setting values. Therefore, it is possible to prevent a potential error.

Incidentally, if data of a sufficient number of image forming apparatuses is not collected in the server 30, statistical data cannot reflect market data. Consequently, although setting values of an image forming apparatus are set as normal values, the setting values are sometimes determined as outliers. A part of reasons for this is that, since statistical data of the server 30 is calculated mainly from data of an online image forming apparatus, a tendency of setting values of an offline image forming apparatus to which data is rarely uploaded is not fully reflected.

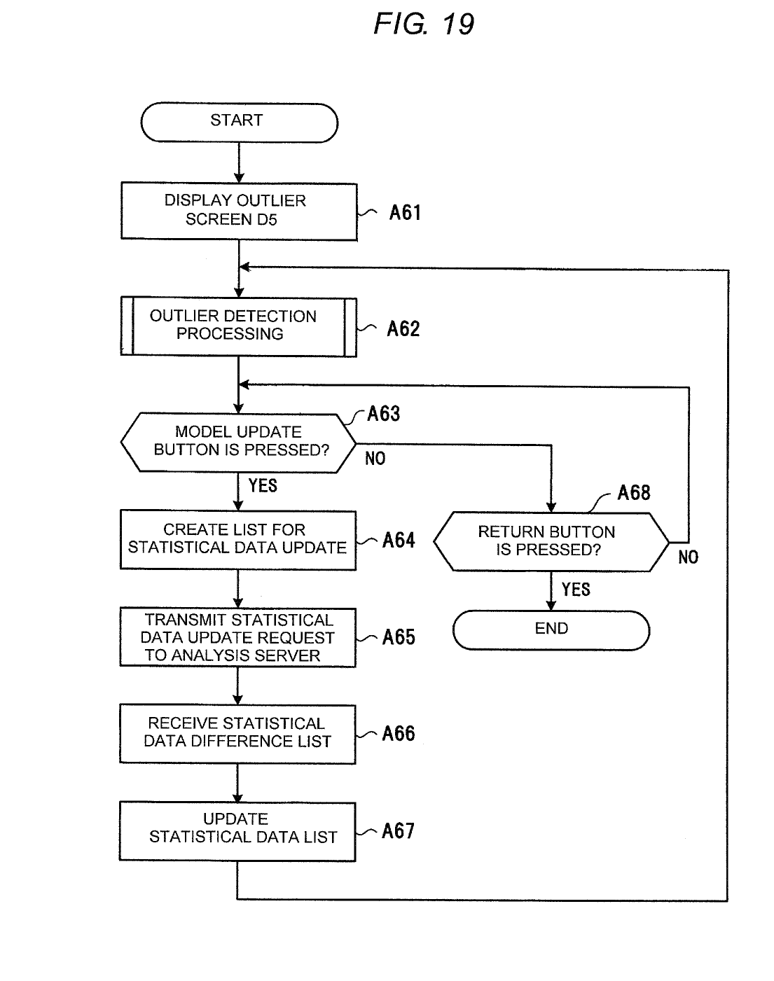

Therefore, if sufficient data is not collected, the maintenance apparatus 10 notifies the server 30 of a setting value determined as an outlier and causes the server 30 to update the statistical data to change the setting value to a normal value. The operation of update processing for the statistical data is explained below with reference to a flow chart of FIG. 19.

If the outlier-of-setting button 75 is selected on the analysis screen D4 for apparatus information shown in FIG. 13, in Act A61, according to the application 131 executed by the processing unit 11 of the maintenance apparatus 10, the CPU 11 displays the outlier-of-setting screen D5 (FIG. 14). Further, the CPU 11 executes the outliner detection processing in Act A62. The outliner detection processing is as explained with reference to FIG. 18. Therefore, explanation of the outliner detection processing is omitted.

In the next Act A63, the CPU 11 waits for an input from the user and determines whether the model update button 79 is pressed on the setting outliner screen D5. When the model update button 79 is pressed in Act A63 (YES in the determination in Act A63), in Act A64, the CPU 11 acquires a setting code set in a selected state and creates a list for statistical data update anew.

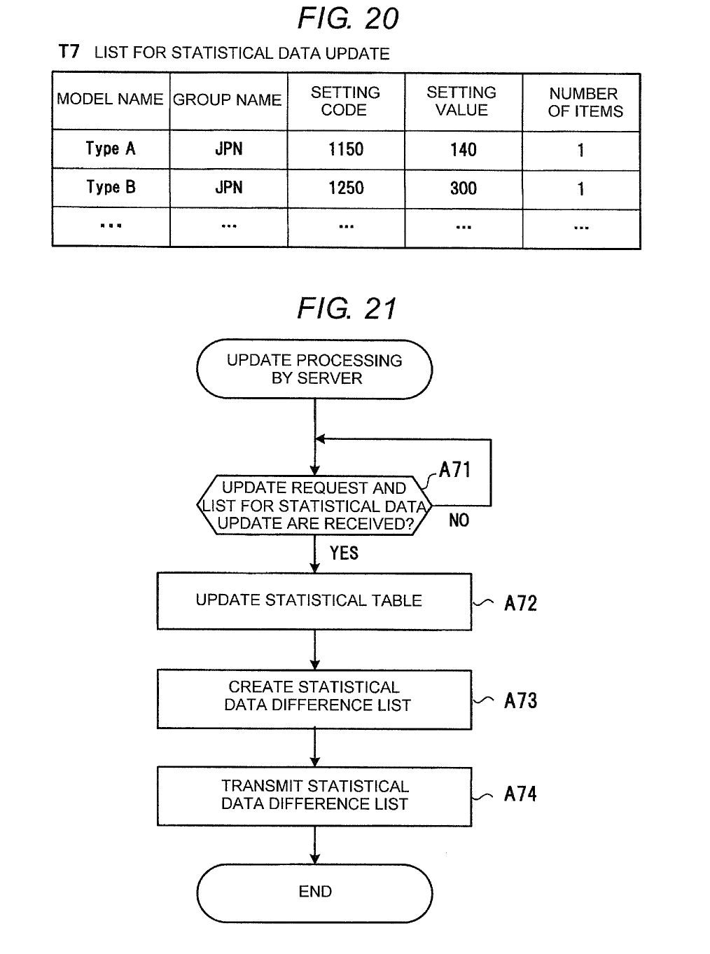

That is, in Act A64, the CPU 11 acquires a model name, a setting code, and a setting value, scans the table for apparatus information T1 concerning a serial number and the model name, acquires a group name, and creates a list for statistical data update T7 shown in FIG. 20. A row in which the check button 78 is not changed to a selected state by the user means a setting value regarded as a normal value by the user.

As shown in FIG. 20, the list for statistical data update T7 includes the model name, the group name, the setting code, and the setting value and the number of items is inserted as 1. If rows whose model names, group names, setting modes, and setting values overlap are already present, 1 is added to the number of items and a redundant row is not formed. When all setting codes for which the check button 78 are in the selected state are finished to be inserted into the list for statistical data update T7, in Act A65, the CPU 11 transmits the list for statistical data update T7 and a statistical data update request to the server 30 via the network I/F 17.

In the next Act A66, the CPU 11 waits for data for update to be transmitted from the server 30 and receives the data for update via the network I/F 17. Therefore, the network I/F 17 configures a transmitting and receiving unit that transmits an update request for statistical data to the server and receives information subjected to update processing in the server.

A format of the list for update is the same as the format of the statistical data list T4 (FIG. 7). In Act A67, the CPU 11 scans the statistical data list T4 concerning the model name, the group name, and the setting code of the data for update and replaces a row corresponding to the model name, the group name, and the setting code with a row of the data for update to thereby update the statistical data list T4.

The CPU 11 returns to Act A62 and executes the outlier detection processing again on the basis of the updated statistical data list T4. Therefore, anew result is displayed on the outlier display section 76 of the outlier-of-setting screen D5 (FIG. 14).

If the model update button 79 is not pressed in Act A63 (NO in the determination in Act A63), in Act A68, the CPU 11 determines whether the return button 77 is pressed. If the return button 77 is not pressed in act A68 (NO in the determination in Act A68), the CPU 11 returns to Act A63. If the return button 77 is pressed in Act A68 (YES in the determination in Act A68), the CPU 11 leaves the flowchart of FIG. 19.

Upon receiving the list for statistical data update T7 and the statistical data update request from the maintenance apparatus 10, the server 30 updates the statistical data list T4 and transmits an update result to the maintenance apparatus 10. This operation is explained with reference to a flowchart of FIG. 21.

In FIG. 21, in Act A71, the server 30 determines whether statistical data update request and the list for statistical data update T7 are received from the maintenance apparatus 10. If the determination in Act A71 is YES, in Act A72, the server 30 searches through the statistical data list T4 concerning the model name, the group name, and the setting code of the list for statistical data update T7. If a row coinciding with the model name, the group name, and the setting code is present in the statistical data list T4, the server 30 updates the average, the mode, and the number of samples of the statistical data list T4 using the setting value and the number of items of the list for statistical data update T7.

Further, if the setting value is outside the range of the threshold, the server 30 replaces the upper limit or the lower limit with the setting value such that the setting value is within the threshold. For example, when the lower limit θ1 is 150, the upper limit θh is 350, and the setting value is 140, the server 30 updates the lower limit θ1 to 140. For example, when a threshold of a setting code 1150 of the statistical data list T4 shown in FIG. 7 is “150, 350”, the server 30 updates the threshold to “140, 350”.

In addition to the update of the threshold, the server 30 updates the average and the standard deviation such that the setting value is determined as a normal value when a Mahalanobis distance is calculated. The server 30 calculates an average and a standard deviation while increasing arbitrary weight on the setting value such that the setting value is fit within a range of the average±Z×the standard deviation. Z is 1, 2, or 3 or an arbitrary threshold set in a system. A value same as the threshold on the maintenance apparatus 10 side is used as Z. If the setting value is a nominal scale, the mode and the threshold of the statistical data list are updated.

In the outlier-of-setting screen D5 shown in FIG. 14, an average “300.5” of the setting code 1150 is updated to be closer to “140”. For example, if it is specified that the setting value is normal as long as the setting value is within a range of the average±150, an allowable range is the average 300.5±150. Therefore, the setting value 140 is an outlier. In this case, the average 300.5 is weighted and corrected to, for example, 280. Consequently, the allowable range changes to 280±150 and the setting value 140 is a normal value. Therefore, the average 300.5 of the statistical data list T4 (FIG. 7) is updated to 280.

When the update of the statistical data list T4 corresponding to the model name, the group name, and the setting code in the list for statistical data update T7 ends, in Act A73, the server 30 acquires, from the statistical data list T4, a row coinciding with the model name, the group name, and the setting code included in the list for statistical data update T7 and creates a statistical data difference list. Finally, in Act A74, the server 30 transmits the statistical data difference list to the maintenance apparatus 10 via the network I/F 17 and ends the processing in the server 30.

A format of the statistical data difference list is the same as the format of the statistical data list T4. Among the items of the number of samples, the average, the mode, the standard deviation, and the threshold, only values of updated items are transmitted to the maintenance apparatus 10 as a difference list. For example, if the threshold is updated to “140, 350” and the average is updated to “280”, only data of the items of the threshold and the average is transmitted as the difference list.

After the difference list is transmitted from the server 30, the CPU 11 proceeds to Act A66 in FIG. 19. Thereafter, the statistical data list T4 is updated by the processing unit (the CPU) 11. If the detection of an outlier is performed in Act A62, an updated item is removed from the outlier display section 76 of the outlier-of-setting screen D5 (FIG. 14) because the updated item does not correspond to the outlier. Therefore, an outlier not intended by the serviceperson can be excluded from the list.

As explained above, the maintenance apparatus 10 according to the embodiment acquires apparatus information of the image forming apparatus 20 via the detachable external storage medium such as the USB memory 40. The maintenance apparatus 10 can compare a statistical value of apparatus setting and a setting value of the image forming apparatus with statistical information of market data collected by the server 30, detect an outlier (a comparison result), and present the outlier on the screen of the maintenance apparatus 10.

Therefore, when the service person maintains the image forming apparatus 20 in the setting place, it is possible to detect and present an outlier. It is possible to prevent occurrence of an error by adjusting a setting value on the spot.

Even if data of the image forming apparatus 20 is not sufficiently collected by the server 30, if the statistical data list of the server 30 is updated, the maintenance apparatus 10 can reduce the likelihood that a normal value is determined as an outlier and more accurately perform outlier detection for a setting value. At the same time, the server 30 can change the statistical data to statistical data that further reflects market data.

In the embodiment, the maintenance apparatus 10 can also be configured by a PC alone. However, a maintenance apparatus can be configured by the PC and the server 30. For example, a part of functions of the PC may be provided in the server 30 and various analysis results may be displayed on the PC using information received from the server 30.

The image forming apparatus is explained as an example of a maintenance target apparatus. However, the maintenance target apparatus of the maintenance apparatus is not limited to the image forming apparatus. For example, the maintenance apparatus can set, as the maintenance target, various information processing apparatuses such as a POS (point of sale) terminal set in a commercial facility or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A maintenance method for an information processing apparatus comprising:
acquiring identification information for identifying the information processing apparatus and apparatus information including setting value information of a plurality of setting items of the information processing apparatus;
acquiring statistical data created on the basis of the setting value information of a plurality of the information processing apparatuses;
comparing the setting value information and the statistical data for each of the plurality of setting items and presenting information concerning a setting item including an outlier;
transmitting, concerning the setting item including the presented outlier, if a request for update of statistical data corresponding to the setting value is input, an update request for the statistical data to a server; and
receiving information subjected to update processing in the server and updating the corresponding statistical data.

2. The method according to claim 1, further comprising:
creating and transmitting a list for statistical data update in transmitting the update request for the statistical data to the server; and
subjecting statistical data listed in the list for statistical data update to update processing in the server.

3. The method according to claim 1, further comprising:
receiving, after subjecting the statistical data to the update processing in the server, a difference list of the statistical data before the update processing and the statistical data after the update processing from the server; and
updating the statistical data on the basis of the difference list.

4. The method according to claim 2, wherein the updating the statistical data is recalculating and updating a setting value included in the list for statistical data update such that the setting value can be determined as a normal value.

5. The method according to claim 1, further comprising performing detection processing for the outlier on the basis of the updated statistical data and, when there is no more outlier, deleting the presentation.

6. A maintenance apparatus for an information processing apparatus comprising:
an apparatus-information acquiring unit configured to acquire identification information for identifying the information processing apparatus and apparatus information including setting value information of a plurality of setting items of the information processing apparatus;
a statistical-data acquiring unit configured to acquire statistical data created on the basis of the setting value information of a plurality of the information processing apparatuses;
an outlier detecting unit configured to compare the setting value information and the statistical data for each of the plurality of setting items and present information concerning a setting item including an outlier to a display unit;
an inputting unit configured to request, concerning the setting item including the presented outlier, update of the statistical data corresponding to the setting item;
a transmitting and receiving unit configured to transmit an update request for the statistical data received from the input unit to a server and receive information subjected to update processing by the server; and
a processing unit configured to receive the information subjected to the update processing and update, on the basis of the received information, the statistical data acquired by the statistical-data acquiring unit.

7. The apparatus according to claim 6, wherein the transmitting and receiving unit creates and transmits a list for statistical data update in requesting the server to update the statistical data.

8. The apparatus according to claim 6, wherein
the transmitting and receiving unit receives a difference list of the statistical data before the update processing and the statistical data after the update processing from the server, and
the processing unit updates the statistical data on the basis of the difference list.

9. The apparatus according to claim 7, wherein the update processing for the statistical data in the server is recalculating a setting value included in the list for statistical data update such that the setting value can be determined as a normal value.

10. The apparatus according to claim 6, wherein the outlier detecting unit performs detection processing for the outlier on the basis of the updated statistical data and, when there is no more outlier, deletes the presentation of the outlier in the display unit.
